(19) United States
(12) Patent Application Publication
(10) Pub. No.: US 2026/0100987 A1
(43) Pub. Date: Apr. 9, 2026

(54) VIRTUAL OPEN TELEMETRY SPANS

(71) Applicant: Cisco Technology, Inc., San Jose, CA (US)

(72) Inventors: Walter Theodore HULICK, Jr., JR., Pearland, TX (US); Thomas SZIGETI, Vancouver (CA); David John ZACKS, Vancouver (CA)

(21) Appl. No.: 18/909,729

(22) Filed: Oct. 8, 2024

(51) Int. Cl. H04L 67/1396; H04L 67/51; H04L 67/54

(52) U.S. Cl. CPC H04L 67/1396; H04L 67/51; H04L 67/54

(57) ABSTRACT

In one embodiment, a method herein comprises: collecting, by an agent on a device, telemetry data based on operation of the device; processing, by the agent, the telemetry data to establish an enhanced assessment in relation to the telemetry data; generating, by the agent, a contextually informative notation based on the enhanced assessment established in relation to the telemetry data; and transporting, from the agent, a virtual telemetry span based on the telemetry data and containing the contextually informative notation toward a collector configured to process the virtual telemetry span as part of an associated trace for insight into the operation of the device.

### TECHNICAL FIELD

The present disclosure relates generally to computer networks, and, more particularly, to virtual open telemetry spans.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

In particular, a business transaction for an application (or “application transaction”) refers to the end-to-end, cross-tier processing path used to fulfill a request for a service provided by the application. For instance, in a retail application, a business transaction may correspond to user actions such as a user searching for a particular item, adding that item to their cart, beginning the checkout process, and completing payment of their purchase. Each of these actions may have associated actions within the application, such as making application programming interface (API) calls to an inventory service, a payment processing service, etc.

Open Telemetry is a fairly new technology that produces and shares observed metrics within a computer network, such as from applications executing within the network and the devices on which such applications are executed. Open Telemetry spans, in particular, are currently used mainly to build a trace and specify individual work done in the trace. However, these spans do not provide much more to a story of observation than the metrics observed, and technicians currently are burdened with navigating through an overwhelming number of spans in order to interpret the observed metrics, accordingly.

### BRIEF DESCRIPTION OF THE DRA WINGS

The embodiments herein may be better understood by referring to the following description in conjunction with the accompanying drawings in which like reference numerals indicate identically or functionally similar elements, of which:

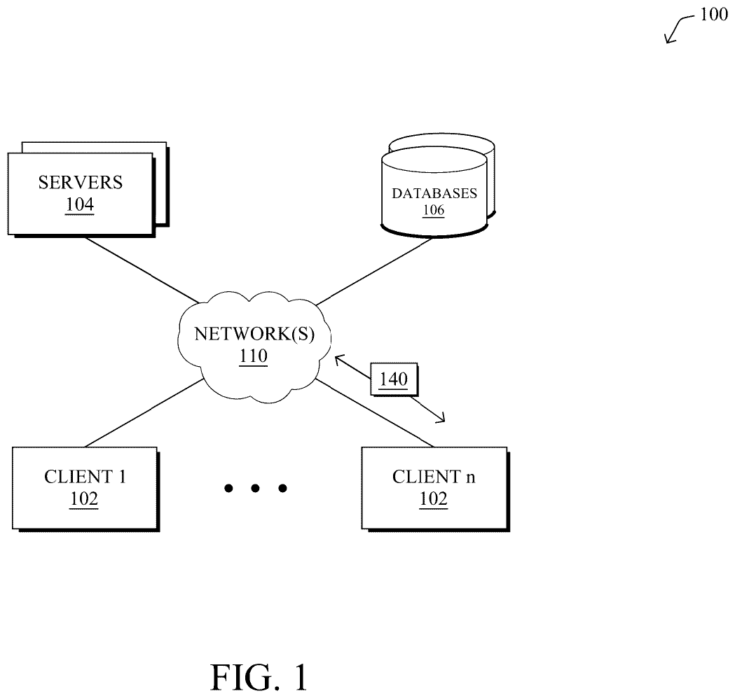

FIG. 1 illustrates an example computing system;

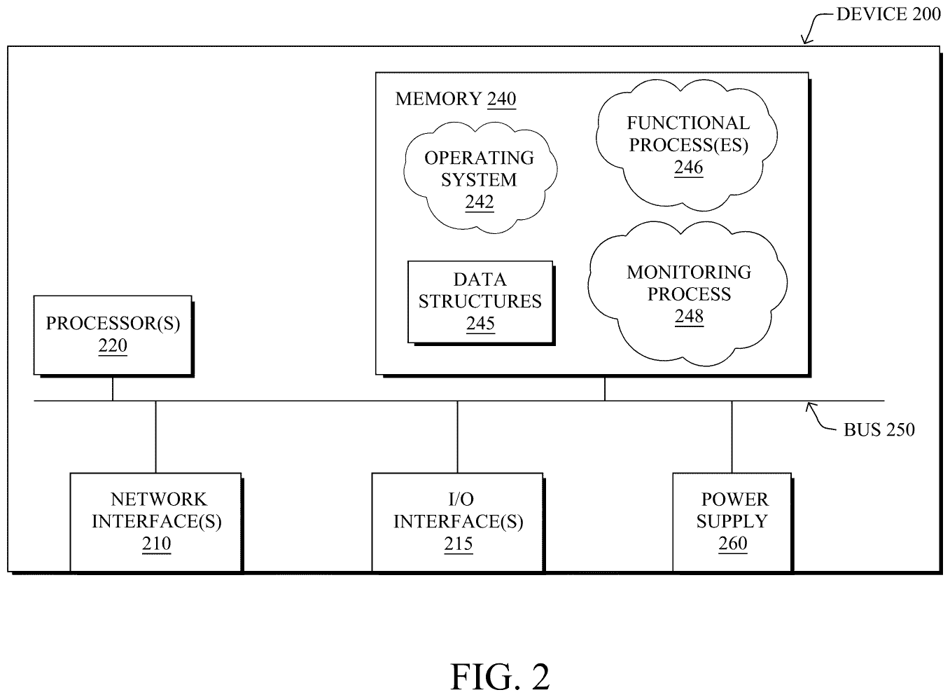

FIG. 2 illustrates an example network device/node;

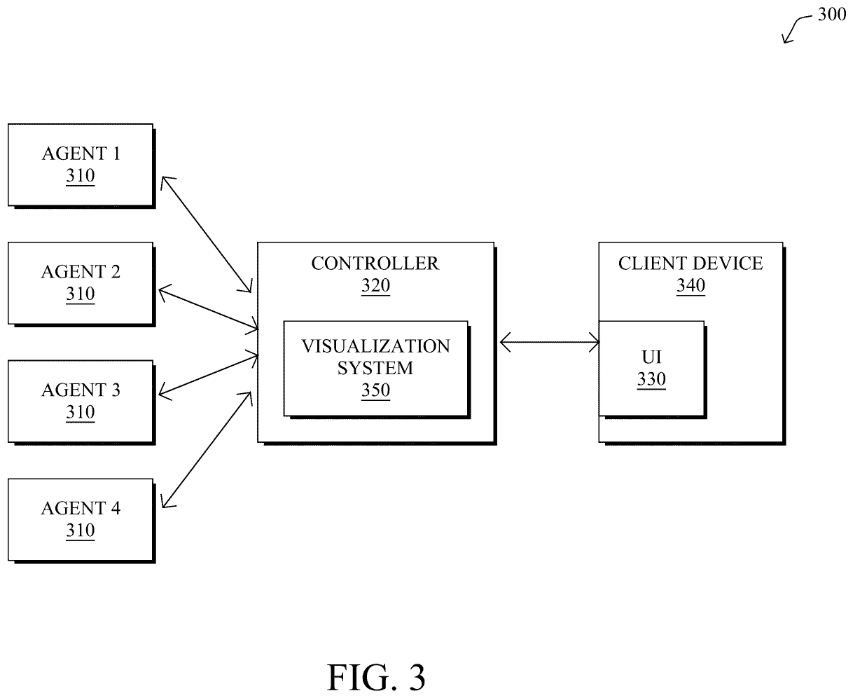

FIG. 3 illustrates an example observability intelligence platform;

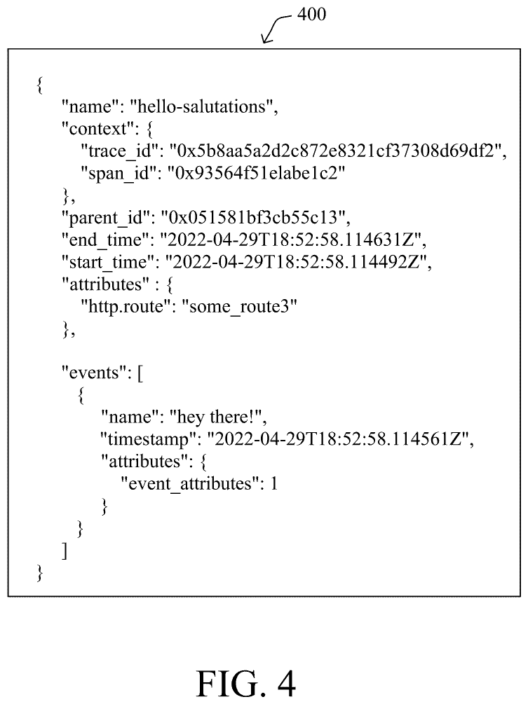

FIG. 4 illustrates an example format for a span;

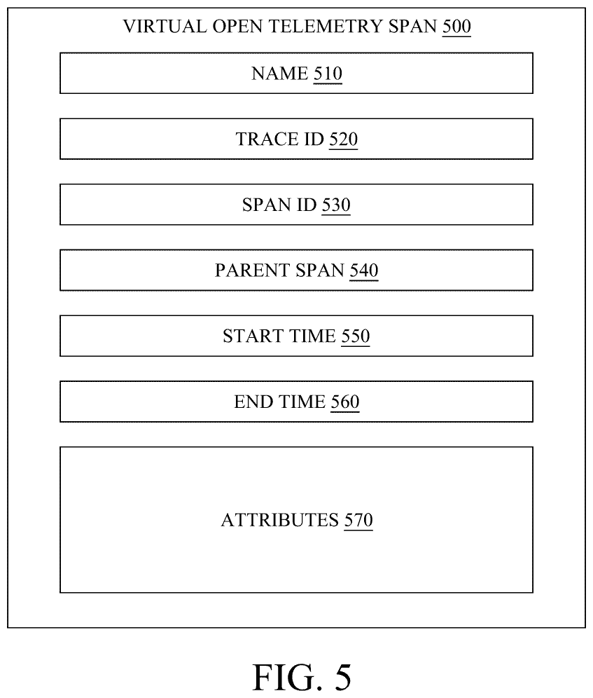

FIG. 5 illustrates a simplified block example of contents of a virtual span

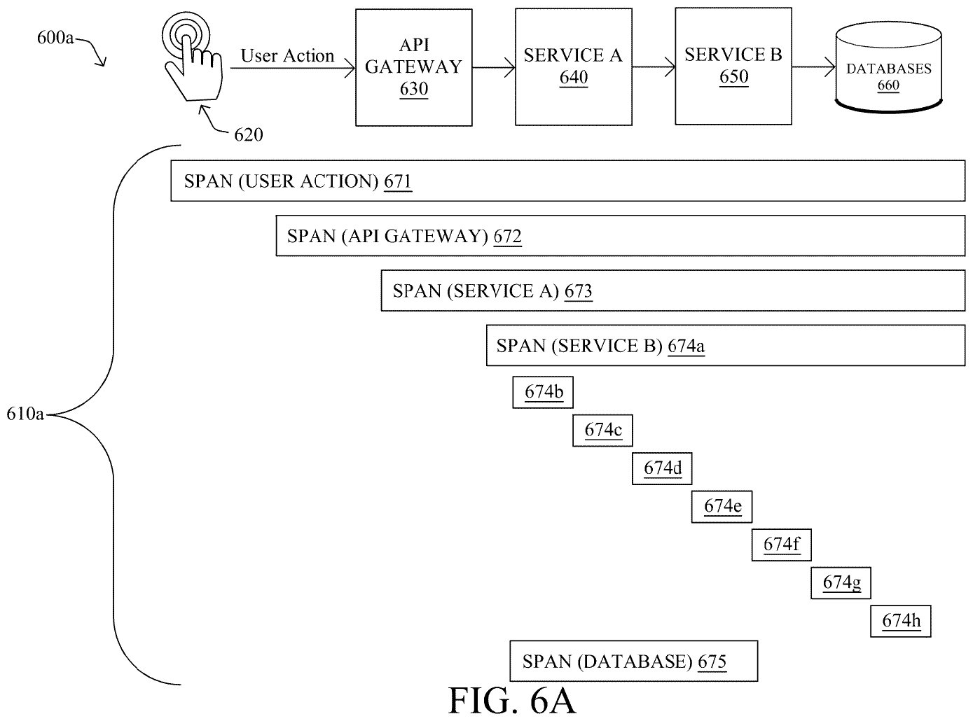

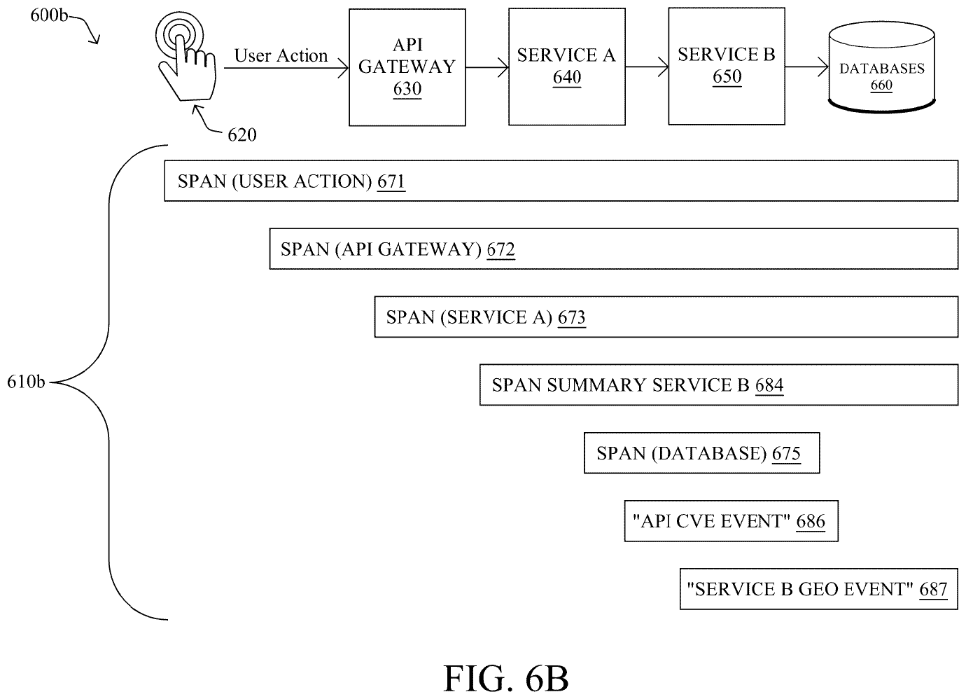

FIGS. 6A-6B illustrate examples of traces with conventional spans and virtual spans;

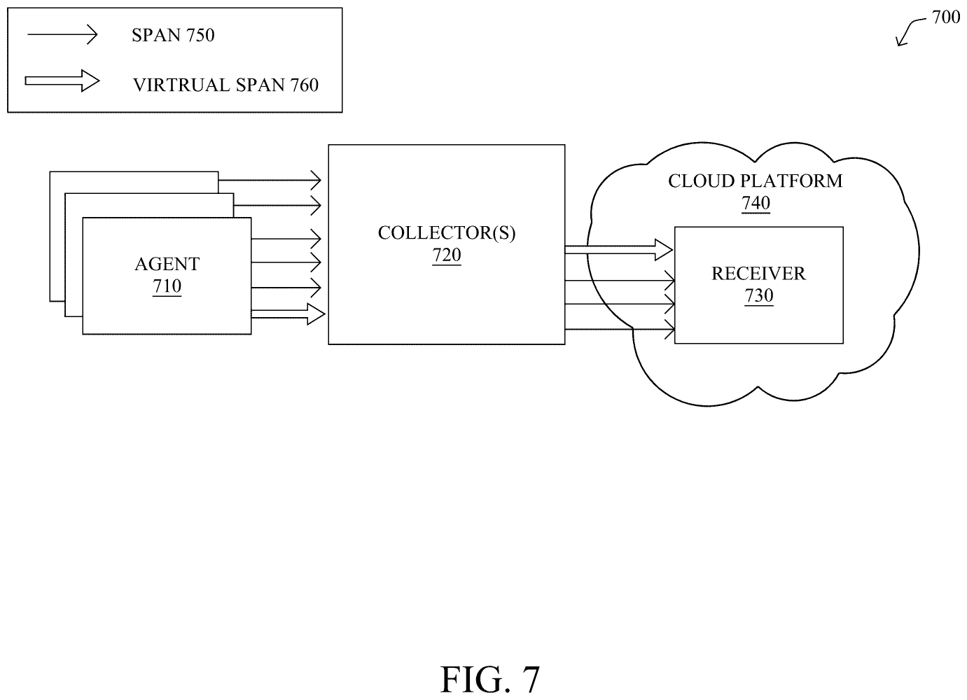

FIG. 7 illustrates an example of a virtual telemetry span collection system; and

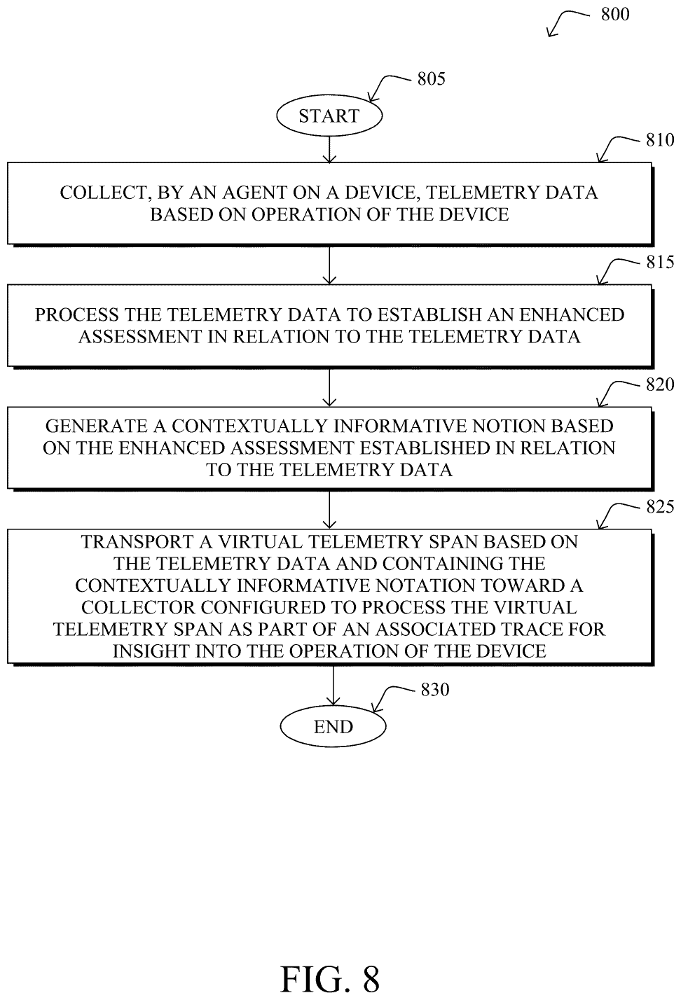

FIG. 8 illustrates an example procedure for providing virtual open telemetry spans.

### DESCRIPTION OF EXAMPLE EMBODIMENTS

### Overview

According to one or more embodiments of the disclosure, virtual open telemetry spans are provided herein. In one embodiment, an example method herein may comprise: collecting, by an agent on a device, telemetry data based on operation of the device; processing, by the agent, the telemetry data to establish an enhanced assessment in relation to the telemetry data; generating, by the agent, a contextually informative notation based on the enhanced assessment established in relation to the telemetry data; and transporting, from the agent, a virtual telemetry span based on the telemetry data and containing the contextually informative notation toward a collector configured to process the virtual telemetry span as part of an associated trace for insight into the operation of the device.

In one embodiment, the enhanced assessment comprises summarization of a plurality of span-inducing information, and the contextually informative notation comprises a corresponding summary of the plurality of span-inducing information. In another embodiment, the enhanced assessment comprises a determination of circumstantial information, and the contextually informative notation comprises a corresponding description of the circumstantial information.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a monitoring process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

Notably, the techniques herein may employ any number of machine learning techniques, such as to evaluate ingested data as described herein. In general, machine learning is concerned with the design and the development of techniques that receive empirical data as input (e.g., collected metric/event data from agents, sensors, etc.) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, the techniques herein can use the model M to classify new data points. Often, M is a statistical model, and the cost function is inversely proportional to the likelihood of M, given the input data.

One class of machine learning techniques that is of particular use herein is clustering. Generally speaking, clustering is a family of techniques that seek to group data according to some typically predefined or otherwise determined notion of similarity.

Also, the performance of a machine learning model can be evaluated in a number of ways based on the number of true positives, false positives, true negatives, and/or false negatives of the model.

In various implementations, such techniques may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may attempt to analyze the data without applying a label to it. Semi-supervised learning models take a middle ground approach that uses a greatly reduced set of labeled training data.

Example machine learning techniques that the techniques herein can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### —Observability Intelligence Platform—

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (agents 310) and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller instance may be installed locally and self-administered.

The controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Furthermore, for reference, the following discussion is a brief primer on OpenTelemetry:
An “OpenTelemetry Trace” is defined as one or more OpenTelemetry Spans with all Spans sharing a common trace ID.
An “OpenTelemetry Span” is reported from a monitored application by an OpenTelemetry SDK or auto-instrumentation agent and includes:
   A pointer to the “parent” span, the span that captures what happened immediately before this one;
   A set of attributes: Key/Value pairs with information about the running program;
   A status: to indicate whether the application hit an error while processing this part of the request;
   A span kind: helps describe what action this span captures (call entering/leaving a service, internal to the service, etc.);
   A set of resource attributes: Key/Value pairs with information about where the span came from;
   A name to summarize the operation the span represents; and
   A start and end time.

An OpenTelemetry system thus creates and/or ingests batches of spans from various sources (agents and collectors) into a backend system such as that described above. Notably, spans may be grouped by trace IDs into trace messages, and the trace messages may be processed, starting at the root, and following all parent-child links.

Each span in the traversal is evaluated as a potential starting point for a business transaction. (Note that business transactions can be nested.) In particular, evaluation criteria this can be based off of may be as follows:
Name;
The position of the span in the trace;
Span kind;
Resource attributes;
Span attributes;
Etc.
   Furthermore, the rules that define conditions on these criteria can be defined by:
The system (“out of the box”/automatic rules);
Machine learning algorithms evaluating the ingested data;
A user (custom rules);
And so on.

Once any criteria is met, a Business Transaction (BT) Entity gets created. Metrics are then reported for the BT based on the status, start, and end time of the span that discovered it. All subsequent traversal of this trace will then report data in the “context” of this BT.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### —Virtual Open Telemetry Spans—

As noted above, Open Telemetry spans are currently used mainly to build a trace and specify individual work done in the trace. However, these spans do not provide much more to a story of observation than the metrics observed, and technicians currently are burdened with navigating through an overwhelming number of spans in order to interpret the observed metrics, accordingly. However, as described herein, spans could be used another way—to tell a story and do a lot more than just report performance data about a single unit of work. That is, the techniques herein can create traces that provide far more info and insight that is valuable to enterprises and cloud providers than the Open Telemetry community has yet considered.

The techniques herein, in particular, provide for virtual open telemetry spans as an innovative way to add more granular descriptive metadata to Open Telemetry traces. In addition, in one embodiment, the techniques herein also provide a “summary” mechanism which can be used to cut down on the amount of tracing data sent to backend receivers.

Specifically, according to one or more embodiments of the disclosure as described in detail below, an agent on a device may collect telemetry data based on operation of the device, and processes the telemetry data to establish an enhanced assessment in relation to the telemetry data. The agent may then generate a contextually informative notation based on the enhanced assessment established in relation to the telemetry data, and transports a virtual telemetry span based on the telemetry data and containing the contextually informative notation toward a collector. The collector is then configured to process the virtual telemetry span as part of an associated trace for insight into the operation of the device. In one embodiment as detailed below, the enhanced assessment comprises summarization of a plurality of span-inducing information, and the contextually informative notation comprises a corresponding summary of the plurality of span-inducing information. In another embodiment as detailed below, the enhanced assessment comprises a determination of circumstantial information, and the contextually informative notation comprises a corresponding description of the circumstantial information.

As a reminder, Open Telemetry (or “OTEL”) generally refers to a collection of tools, application programming interfaces (APIs), and/or software development kits (SDKs). OTEL may be used to instrument, generate, collect, and/or export telemetry data (e.g., metrics, logs, and traces) that assist in analyzing the performance and behavior of a software system, as well as applications that are executed by the software system.

Notably, as will be understood by those skilled the art, an OTEL “span” is a data structure which represents a unit of work or an operation (e.g., within a transaction). Spans are the building blocks of traces, which are essential to understanding the full “path” a request takes in an application. Each Span is an observability-based data structure that encapsulates a number of states, such as an operation name, start and end timestamps, and a number of attributes (key-value pairs), among other fields (e.g., events, link, and so on).

In particular, as will be appreciated, a trace is generally a collection of parent/child spans, which are created during a transaction process. Each Span defines a “transition” in the trace (e.g., a web service call, web service entry, thread transition, etc.) process. Each span carries information about the span in “attributes,” as illustrated in the following pseudocode:

//Get current Span
Span span = Span.current( );
//Add custom attributes to Span
span.setAttribute(“SchoolName”, schoolname);

These attributes are eventually transmitted via a collector/exporter to a backend (e.g., backend receivers) via a wire protocol (e.g., via the Open Telemetry protocol (OTLP)—https://opentelemetry.io/docs/specs/otel/protocol/) and processed at the backend. That is, an Open Telemetry trace is made up as a series of spans—parent/child and they represent a flow and unit of work—each of which is eventually (if sampled) sent to a “collector” which exports them to a receiver to be recorded and eventually analyzed—and to then appear in a dashboard to visualize the trace.

Normally, according to the Open Telemetry specification, a span is a web service call that is part of a transaction, and has an associated response time. In essence, a span is a single operation. However, the Open Telemetry standard does not enforce what is contained within the span. That is, the collector and the receiver will take whatever is sent so long as it matches the specification.

In Java, an API for a span (described at https://javadoc.io/doc/io.opentelemetry/opentelemetry-api-trace/latest/io/opentelemetry/api/trace/Span.html) allows for the following:
Add Events;
Add Exceptions;
Add Status;
Set Attributes.

On the “wire”, a span is transmitted over OTLP to a receiver. FIG. 4 illustrates an example format for a span 400.

Operationally, the techniques herein establish “virtual spans” that allow for a more “proactive” and “descriptive” trace. For instance, certain commentary or enhanced assessment notations may be included within a specially configured span, which may be based on special processing by the OTEL agent on a device.

Certain examples of this additional commentary may include such circumstantial information as geographic locations/transitions (e.g., longitude/latitude) to show where a transaction traveled, security events (e.g., flagging when web service calls go outside a company network), optimization suggestions (e.g., “recording is turned on—this costs money for cloud computing and increases response time”), and so on. Other examples may include such intuitive things as adding comments to the trace such as “I'll be deprecated in two weeks” or “I need an upgrade” or “I've seen some performance issues last night-here's my location in code” or “I have a Common Vulnerabilities and Exposures (CVE) issue that needs attention”. The opportunities presented by the techniques herein are expansive, allowing an agent to process telemetry data (regarding the application, the device, the network, or other measurable metrics) to establish an enhanced assessment and to generate an associated contextually informative notation based thereon (e.g., descriptive commentary and/or notices). This resultingly allows for much greater insight into the operation of the device than previously made available by conventional Open Telemetry operation, accordingly. Those mentioned herein are merely examples of possible assessments and/or commentary, and they are not meant to be limiting to the scope of the present disclosure.

Additionally, in one embodiment herein, the enhanced assessment may comprise a summarization of span information. For example, a “summary” span for certain key spans would be configured to summarize attributes that were sampled out into a single virtual span, rather than creating a span for each event. That is, sampling, and particularly congestion from poor sampling, is an important factor for Open Telemetry, and the techniques herein address this by allowing periodic generation of a summarization span for sampled-in spans that gives a summary for this span of how many times something was sampled out and not reported (e.g., what the time spent in that sample was).

For instance, assume that a function is called and it creates a span. Now assume that every transaction for this function is iterated hundreds of times. This would result in hundreds of corresponding spans, often with the same information (e.g., bandwidth, memory, CPU, etc.). The techniques herein allow for an agent to wait (e.g., a given length of time, a given number of iterations, until an indication of a function being complete, etc.) before summarizing a cumulative representation of the result of those iterations. That is, rather than sending hundreds of spans, the techniques herein would inform the system within a single summary span that this event has happened hundreds of times (e.g., a “rollup” in the span “summarizing” the information to be centrally processed). This summarization would thus save a tremendous amount of bandwidth through the network and a correspondingly large amount of tail-end processing (whether by a receiver or by an analyst reviewing through individual spans).

According to one or more aspects of the present disclosure, one or more indicators in the span could be used to demarcate the virtual span as opposed to a traditional span. For instance, a newly defined ENUM (enumeration) value could be set and used in a field such as Span.KIND INTERNAL (e.g., indicating configuration of the virtual telemetry span to a collector via an enumeration within a span type field of the virtual telemetry span). Any receiver then in receipt of such a virtual span would then recognize the virtual span and process it accordingly. Any receiver that does not recognize it could just discard it.

FIG. 5 illustrates a simplified block example of contents of a virtual span 500 in accordance with one or more embodiments herein.

For Name 510, the techniques herein may use a more “decorative” or “descriptive” phrase that would be the description for the virtual span (e.g., “CVE detected”, “geo change”, etc.), as noted above. Also, for summary spans, the name field could be formatted as something like “Summary: TYPE”, with “TYPE” indicating the type of summarization to be found within the virtual span.

Trace ID 520 is the original trace ID in the current span.

Span ID 530 may be newly created by the OTEL SDK, and would become the current span.

Parent Span 540 indicates the current span.

Start Time 550 is a new timestamp indicating when the span was created.

End Time 560 may vary based on whether the virtual span is “decorative or descriptive” or a summary span. For virtual spans that are carrying commentary, the End Time 560 may be the same as the Start Time timestamp (e.g., latency=0), defining a unit of work (e.g., where an end time field of the virtual telemetry span is set to match a start time field to indicate zero time associated with the virtual telemetry span). For “summary” virtual spans (incorporating multiple operations), the End Time may be a timestamp after all operations are completed.

For Attributes 570, any attributes related to information that needs to be related to the virtual span. That is, for “decorative or descriptive” spans relaying commentary and/or notices, this field may include any pertinent information relative to the name of the span (e.g., actual geo locations, error codes, recommended actions, and so on). For “summary” virtual spans, the attributes may report a summary for the current span with attributes that sent the sampled out count, sampled in count, and over time spent in the span, among other notable information that may be beneficial for a summarization (e.g., max, min, average, standard deviation, etc.).

FIGS. 6A-6B illustrate examples of traces, where FIG. 6A illustrates an example 600a of a trace 610a of a user action 620 passing illustratively through an API gateway 630, a Service A 640, a Service B 650, and a database 660. A number of spans (671, 672, 673, 674a-h, and 675) may be generated for this trace 610a, where, for example, the width of the span is representative of the timing of the action being taken by each component. As can also be seen, assume that Service B produces a number of iterations with correspondingly generated spans (674a-h) for the trace 610a.

In general, these spans 671-675 are not usually descriptive in terms of the “names”. For instance, while simplified names “API Gateway” and “Service A” etc. have been shown, typical naming conventions may be things such as: “Frontend: HTTP Get” or “Driver” or “Redis”. The techniques herein allow for the spans to make this more descriptive in at least some (or even all) of the virtual spans that essentially would be inserted and mark “transitions” by name, such as: “Transition to worker thread, 5 threads available” or “Web Service Call being made to Visa” or a summary span “Summary: Span sampled out four hundred times last minute” or “Inbound Web Service Call from China”. These types of names would allow for easy insight into the trace from the perspective of an analyst or other process. While certain information may be added to the attributes field of a span, an analyst would have to examine (e.g., click into) each span one at a time looking for relevant information. Since a single trace may be comprised of hundreds of spans, this would be very time consuming.

FIG. 6B, therefore, illustrates another example 600b of a trace 610b of the user action 620, where a number of spans may be generated for this trace 610b, where, for example, some of the spans remain the same (e.g., 671, 672, 673, and 675), while some have been created from virtual spans as described herein. In particular, assume that Service B still produced the number of iterations as before, but now a “Summary Service B” virtual span 684 has been created with correspondingly summarized information for the originally generated spans (674a-h) of the trace 610a above. Also, a descriptive virtual span, virtual span 686, has been created to note that the API has had a CVE event during the trace, and perhaps another virtual span 687 may have indicated that Service B had a Geo Event. (As described above, more detail may be included in the name of the span, or else within the attributes of the span, and the simplified view of a user interface/dashboard in FIG. 6B is not meant to limit the scope of the present disclosure.)

In this manner, the virtual spans remain compliant with the Open Telemetry standards, yet provide an optimized and expanded functionality for greater details and insight into traces. Notably, the techniques herein may alter the processes used to generate the enhanced assessments over time, including additional features, additional insight, and additional functionality without altering the Open Telemetry specification. Furthermore, various machine learning and/or artificial intelligence may be applied at the agents or otherwise to implement learned behavior indications over time, such as for detecting local anomalies, predicting future failures, and so on, as may be appreciated by those skilled in the art. Such ML/AI processes may thus utilize the virtual spans of the present disclosure to provide new updates and insights as they become apparent.

Notably, the present disclosure further contemplates various configurations of corresponding virtual span processing modules in the collector and/or receiver for the cloud platform. In particular, as mentioned, virtual spans can represent a number of things, such as a summary, a significant boundary in a trace, an actual physical path, and so on, and can also contain performance-related, security-related, or simple context-related information. The collectors and/or receivers, therefore, may be configured accordingly in order to process the spans and virtual spans.

FIG. 7 illustrates a simplified example of a virtual telemetry span collection system, system 700, comprising a plurality of agents (agents 710), one or more collectors (collector(s) 720), and a receiver 730 (within a cloud platform 740), with spans 750 and virtual spans 760 passing from agents 710 to collector(s) 720 and ultimately to receiver 730, as shown.

For example, the following configurations and operations may be established according to the techniques herein:
An agent sends a span to the collector, which forwards it on to the receiver;
An agent sends a virtual span to the collector, which forwards it on to the receiver;
One or more agents send one or more spans to the collector, which generates a virtual span based on those one or more spans from the one or more agents, and sends that virtual span to the receiver; and
One or more agents send one or more virtual spans to the collector, which expands out the one or more virtual spans into a plurality of spans, and sends that plurality of spans to the receiver.

Specifically regarding this last option, another way to make use of virtual spans is to build “Processing Extensions” in the Collector that would process traces and could expand out a single virtual span to replace it with real spans that might represent the single virtual span. For instance, this could be the case when dealing with a virtual span that is a summary, as described above, where this summary virtual span could be repackaged into a new trace that could be sent via an exporter to the receiver within the cloud platform for visualization, accordingly.

Alternatively, the virtual spans could simply “pass through” the collector onward upstream to the cloud platform receiver where it could have a “virtual span” extension plugin that recognizes virtual spans and that can perform additional processing for maximum context of the trace, e.g., that a generic Open Telemetry protocol trace display would not be capable of doing.

Furthermore, by processing virtual spans in accordance with the techniques herein, “Entity Models” may be created, which describe new objects and metrics beyond just simple spans representing a simple link in a trace. This can lead to analysis capabilities that support AI/ML (e.g., LLMs) to create a complex description of a trace, which in its raw form lacks the descriptiveness and context that a true full stack observability intelligence platform can offer, as described herein.

FIG. 8 illustrates an example simplified procedure for providing virtual open telemetry spans in accordance with one or more embodiments described herein, particularly from the perspective of an agent operating on a device. For example, a non-generic, specifically configured device (e.g., device 200, an apparatus) may perform procedure 800 by executing stored instructions (e.g., process 248). The procedure 800 may start at step 805, and continues to step 810, where, as described in greater detail above, the agent collects telemetry data based on operation of the device (e.g., application telemetry, device telemetry, and/or network telemetry).

In step 815, the agent may then process the telemetry data to establish an enhanced assessment in relation to the telemetry data. As described above, in one embodiment, the enhanced assessment may comprise summarization of a plurality of span-inducing information, i.e., summarizing a plurality of other spans into a single virtual span. As also described above, in another embodiment, the enhanced assessment may comprise a determination of circumstantial information (e.g., based on one or more of past events, current status, or future predictions). For instance, as noted, the circumstantial information may be selected from a group consisting of: geographic coordinates; a geo-fence boundary crossing; a geographic region; a network boundary crossing; a security event; a performance issue; an error description; a description of work performed; a description of an event occurring; a description of a transition, and many others. In one embodiment, a determination of circumstantial information may comprise an optimization suggestion (e.g., “do this for better results” or “I need an upgrade”, etc.).

In step 820, the agent may then generate a contextually informative notation based on the enhanced assessment established in relation to the telemetry data. For instance, when the enhanced assessment comprises summarization of a plurality of span-inducing information, then the contextually informative notation may comprise a corresponding summary of the plurality of span-inducing information (e.g., when a plurality of iterations of the same event is summarized, then a single entry indicating the event and the number of times the event iterated may be generated). Alternatively, when the enhanced assessment comprises a determination of circumstantial information, then the contextually informative notation may comprise a corresponding description of the circumstantial information (e.g., when a security event is detected, a description of the security event is generated). Note, too, that for summarizations, the contextually informative notation may further comprise attributes such as: a sampled out count; a sampled in count; a time spent over the plurality of span-inducing information; a maximum; a minimum; an average; and so on.

In step 825, the agent may then transport a virtual telemetry span based on the telemetry data and containing the contextually informative notation toward a collector (e.g., and ultimately toward a receiver). The collector (and/or receiver) may then be configured to process the virtual telemetry span as part of an associated trace for insight into the operation of the device (e.g., insightful operations or displays for analyst review). As described above, within this virtual telemetry span, the contextually informative notation may be contained within a name field of the virtual telemetry span, or within an attribute field of the virtual telemetry span. Also, in one embodiment, the contextually informative notation may be contained within a name field of the virtual telemetry span and merely references the enhanced assessment, while additional information related to the enhanced assessment may be contained within an attribute field of the virtual telemetry span.

Procedure 800 may end at step 830.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

The techniques described herein, therefore, provide for virtual open telemetry spans. Traces traditionally merely always provide the same information: timings, HTTP URI/Ls, etc., but tell no “story” beyond just how long one transaction took to complete. Virtual Spans can fill that gap by providing a more descriptive and insightful commentary to the spans, without altering the OpenTelemetry specification. Additionally, through the summarization techniques herein, analysts need not be forced to choose between having too many spans or not enough spans. That is, instead of spans being always on or always off, or deciding between head-based sampling (e.g., receiving 10% of the possible spans, without knowing what is the other 90%) or tail-based sampling (which receives all spans and then decides which ones to keep, wasting bandwidth), the techniques herein can vastly reduce the overwhelming number of spans through summarization and context, as detailed above.

Illustratively, the techniques described herein may be performed by hardware, software, and/or firmware, (e.g., an “apparatus”) such as in accordance with the monitoring process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: collecting, as an agent on a device, telemetry data based on operation of the device; processing the telemetry data to establish an enhanced assessment in relation to the telemetry data; generating a contextually informative notation based on the enhanced assessment established in relation to the telemetry data; and transporting a virtual telemetry span based on the telemetry data and containing the contextually informative notation toward a collector configured to process the virtual telemetry span as part of an associated trace for insight into the operation of the device.

In still other implementations, a tangible, non-transitory, computer-readable medium storing program instructions that cause a device to execute a process comprising: collecting, as an agent on the device, telemetry data based on operation of the device; processing the telemetry data to establish an enhanced assessment in relation to the telemetry data; generating a contextually informative notation based on the enhanced assessment established in relation to the telemetry data; and transporting a virtual telemetry span based on the telemetry data and containing the contextually informative notation toward a collector configured to process the virtual telemetry span as part of an associated trace for insight into the operation of the device.

In still further implementations, an illustrative example system herein may comprise: a device in a computer network; an agent on the device; and a collector in the computer network; wherein the agent is configured to: collect telemetry data based on operation of the device; process the telemetry data to establish an enhanced assessment in relation to the telemetry data; generate a contextually informative notation based on the enhanced assessment established in relation to the telemetry data; and transport a virtual telemetry span based on the telemetry data and containing the contextually informative notation toward a collector; and wherein the collector is configured to process the virtual telemetry span as part of an associated trace for insight into the operation of the device.

In one embodiment, the system further comprises a receiver, wherein the collector is configured to process the virtual telemetry span and to forward a result of processing the virtual telemetry span onward to the receiver. In still another embodiment, the enhanced assessment comprises summarization of a plurality of span-inducing information, and the contextually informative notation comprises a corresponding summary of the plurality of span-inducing information, and the result of processing the virtual telemetry span comprises a plurality of expanded spans each representing a corresponding component of the plurality of span-inducing information.

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

As used herein, the terms “application” and “applications” generally refer to a computer program or computer programs that are designed to carry out a specific task or tasks other than task(s) relating to the operation of the computer itself. In particular, an “application” can refer to a collection of executable computer code that is provided to, or is integrated into, a software system. As a result, the “application” or “applications” discussed herein can refer to any collection computer code that is executed by, or provided by, the software system.

By way of example, the applications mentioned herein can be host applications that run on various computing systems, such as a physical computer (e.g., a desktop, a laptop, a smartphone, a tablet, a phablet, etc.), a virtual computer (e.g., a thin client, a virtual machine, a Linux container, etc.), a data center (e.g., rack server, supercomputer, etc.), and/or a software defined data center (e.g., bare metal server), etc. Accordingly, the applications described herein can be locally provided host applications, virtually provided host applications, and so on and so forth.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
collecting, by an agent on a device, telemetry data based on operation of the device;
processing, by the agent, the telemetry data to establish an enhanced assessment in relation to the telemetry data;
generating, by the agent, a contextually informative notation based on the enhanced assessment established in relation to the telemetry data; and
transporting, from the agent, a virtual telemetry span based on the telemetry data and containing the contextually informative notation toward a collector configured to process the virtual telemetry span as part of an associated trace for insight into the operation of the device.

2. The method of claim 1, wherein the enhanced assessment comprises summarization of a plurality of span-inducing information, and wherein the contextually informative notation comprises a corresponding summary of the plurality of span-inducing information.

3. The method of claim 2, wherein the contextually informative notation further comprises one or more attributes selected from a group consisting of: a sampled out count; a sampled in count; a time spent over the plurality of span-inducing information; a maximum; a minimum; and an average.

4. The method of claim 1, wherein the enhanced assessment comprises a determination of circumstantial information, and wherein the contextually informative notation comprises a corresponding description of the circumstantial information.

5. The method of claim 4, wherein the determination of circumstantial information is based on one or more of past events, current status, or future predictions.

6. The method of claim 4, wherein the circumstantial information is selected from a group consisting of: geographic coordinates; a geo-fence boundary crossing; a geographic region; a network boundary crossing; a security event; a performance issue; an error description; a description of work performed; a description of an event occurring; and a description of a transition.

7. The method of claim 4, wherein the determination of circumstantial information comprises an optimization suggestion.

8. The method of claim 4, wherein an end time field of the virtual telemetry span is set to match a start time field to indicate zero time associated with the virtual telemetry span.

9. The method of claim 1, wherein the contextually informative notation is contained within a name field of the virtual telemetry span.

10. The method of claim 1, wherein the contextually informative notation is contained within an attribute field of the virtual telemetry span.

11. The method of claim 1, wherein the contextually informative notation is contained within a name field of the virtual telemetry span and references the enhanced assessment, and wherein additional information related to the enhanced assessment is contained within an attribute field of the virtual telemetry span.

12. The method of claim 1, further comprising:
indicating configuration of the virtual telemetry span to the collector via an enumeration within a span type field of the virtual telemetry span.

13. A tangible, non-transitory, computer-readable medium storing program instructions that cause a device to execute a process comprising:
collecting, as an agent on the device, telemetry data based on operation of the device;
processing the telemetry data to establish an enhanced assessment in relation to the telemetry data;
generating a contextually informative notation based on the enhanced assessment established in relation to the telemetry data; and
transporting a virtual telemetry span based on the telemetry data and containing the contextually informative notation toward a collector configured to process the virtual telemetry span as part of an associated trace for insight into the operation of the device.

14. The tangible, non-transitory, computer-readable medium as in claim 13, wherein the enhanced assessment comprises summarization of a plurality of span-inducing information, and wherein the contextually informative notation comprises a corresponding summary of the plurality of span-inducing information.

15. The tangible, non-transitory, computer-readable medium as in claim 13, wherein the enhanced assessment comprises a determination of circumstantial information, and wherein the contextually informative notation comprises a corresponding description of the circumstantial information.

16. A system, comprising:
a device in a computer network;
an agent on the device; and
a collector in the computer network, wherein the agent is configured to: collect telemetry data based on operation of the device; process the telemetry data to establish an enhanced assessment in relation to the telemetry data; generate a contextually informative notation based on the enhanced assessment established in relation to the telemetry data; and transport a virtual telemetry span based on the telemetry data and containing the contextually informative notation toward a collector, and wherein the collector is configured to process the virtual telemetry span as part of an associated trace for insight into the operation of the device.

17. The system as in claim 16, wherein the enhanced assessment comprises summarization of a plurality of span-inducing information, and wherein the contextually informative notation comprises a corresponding summary of the plurality of span-inducing information.

18. The system as in claim 16, wherein the enhanced assessment comprises a determination of circumstantial information, and wherein the contextually informative notation comprises a corresponding description of the circumstantial information.

19. The system as in claim 16, further comprising:
a receiver, wherein the collector is configured to process the virtual telemetry span and to forward a result of processing the virtual telemetry span onward to the receiver.

20. The system as in claim 19, wherein the enhanced assessment comprises summarization of a plurality of span-inducing information, and wherein the contextually informative notation comprises a corresponding summary of the plurality of span-inducing information, and wherein the result of processing the virtual telemetry span comprises a plurality of expanded spans each representing a corresponding component of the plurality of span-inducing information.
